(19) United States
(12) Patent Application Publication
(10) Pub. No.: US 2022/0243643 A1
(43) Pub. Date: Aug. 4, 2022

(54) HPDF OPERATING METHOD FOR AN INTERNAL COMBUSTION ENGINE, INTERNAL COMBUSTION ENGINE AND WORKING DEVICE

(71) Applicant: Technische Universität München, München (DE)

(72) Inventors: Michael JUD, Olang (IT); Georg FINK, Dornbirn (AT)

(21) Appl. No.: 17/622,104

(22) PCT Filed: Jun. 2, 2020
(86) PCT No.: PCT/EP2020/065177

§ 371 Date: Dec. 22, 2021

(30) Foreign Application Priority Data
Jun. 26, 2019 (DE) 10 2019 209 232.2

(51) Int. Cl. F02B 3/08; F02D 41/00

(52) U.S. Cl. CPC F02B 3/08; F02D 19/10; F02D 41/0027

(57) ABSTRACT

The invention relates to an HPDF operation method for an internal combustion engine (100) with internal formation of a mixture and self-ignition, in which, (i) for a combustion cycle of an operation cycle under high pressure, as main fuel (63) at a first time point, the introduction of a nonself-igniting or gasoline engine fuel, and as ignition fuel (64) at a second time point, the introduction of a self-igniting or diesel fuel into a combustion chamber (20) of the internal combustion engine (1) are at least initiated and/or performed, (ii) a self-ignition of the ignition fuel (64) and with the self-ignition a nonself-ignition of the main fuel (63) are effected, and (iii) the self-ignition of the ignition fuel (64) is performed temporally and/or spatially in such a way that the main fuel (63) is ignited at a location (1) and/or in a region of an jet tip (630 and/or a propagation front (630 of a quantity of introduced main fuel (63)—in particular temporally firstly.

The invention relates to an HPDF operation method for an internal combustion engine, an internal combustion engine as well as a working device and, in particular, a vehicle as such.

In the region of internal combustion engines, aspects of environmental compatibility are becoming increasingly important. Particular attention is paid to methane slip, in which unburned methane (or short-chain hydrocarbons in general) escapes from the combustion chamber as a particularly climate-affecting gas and which can be problematic, especially in gas engines, and to particulate formation, which occurs, for example, in diesel engines in connection with soot formation and can be problematic.

With the development of HPDF combustion method (HPDF: high pressure dual fuel), a significant improvement has been achieved with regard to these problems. In this method, nonself-ignition fuels, i.e. gasoline engine fuels, and self-ignition fuels are used simultaneously and injected or introduced under high pressure into the combustion chamber of a respective cylinder of an internal combustion engine, wherein the gasoline engine fuel acts as the main fuel and the self-ignition fuel serves as the ignition fuel for the main fuel via its self-ignition, so that the main fuel is nonself-ignited via the ignition of the self-ignition fuel. It is known that this procedure has so far not been optimal for handling lean combustion regions, which can deliver a particularly high proportion of methane slip, and rich combustion regions, which can deliver a particularly high proportion of soot and thus particulate formation.

It is the task of the present invention to specify an HPDF operation method for an internal combustion engine as well as an internal combustion engine and a working device, in particular a vehicle, as such, in which a leakage of short-chain hydrocarbons, in particular in the sense of methane slip, and particle formation due to soot are reduced compared with conventional operation types of internal combustion engines.

This task is solved by an HPDF operation method according to the invention with the features of the independent claim 1, by an internal combustion engine according to the invention with the features of claim 10 and by a working device according to the invention with the features of claim 11. Advantageous further developments are the subject of the respective dependent claims.

According to a first aspect, the present invention relates to an HPDF operation method for an internal combustion engine with internal formation of a mixture and self-ignition. In the method according to the invention, for a combustion cycle of an operation cycle under high pressure for the introduction of a main fuel at a first time point, the introduction of a nonself-igniting or gasoline engine fuel, and for the introduction of an ignition fuel at a second time point, the introduction of a self-igniting or diesel fuel into a combustion chamber of the internal combustion engine, are at least initiated and/or performed. A self-ignition of the ignition fuel and, with the self-ignition of the ignition fuel, a nonself-ignition of the main fuel are effected. According to the invention, the self-ignition of the ignition fuel is performed temporally and/or spatially in such a way that the main fuel is ignited at a location and/or in a region of an jet tip and/or a propagation front of a quantity of introduced main fuel—in particular temporally firstly.

Temporally speaking, it is not absolutely necessary in every embodiment of the present invention that the tip—absolutely speaking—is temporally ignited firstly. In certain embodiments of the present invention, it is sufficient when the flame does not reach this region via a propagation along the direction of flow from the rear ignition point, but when the combustion of the jet tip is triggered via an interaction with the pilot there. As a result, the fat regions lying spatially just behind the tip firstly remain unburned and can continue to mix—in particular with the ambient air. Since the flame, for example, also has to start up against the flow, this propagation will be in particular proportionally slow.

By igniting the main fuel comparatively early in the region of the jet tip or propagation front of the main fuel, lean regions occurring there are very likely to be ignited comparatively early, thus reducing the proportion of methane slip. On the other hand, the regions of the main fuel lying on the other side of the propagation front or jet tip have more time to mix with the air in the combustion chamber before ignition, which reduces the proportion of fat regions and thus soot formation.

The required spatial-temporal distribution of main fuel and ignition fuel in the combustion chamber before and during the ignition can be configured in a particularly suitable manner, when, according to a preferred configuration form of the operation method according to the invention, the second time point is not temporally before the first time point and is preferably after the first time point.

In principle, the spatial-temporal distribution of the main fuel and the ignition fuel in the combustion chamber and, in relation to one another, thus the spatial-temporal distribution of the ignition processes can be adjusted on the basis of and taking into account of the geometry of the combustion chamber, of the piston movable therein with the piston crown and the spatial-temporal configuration of the introduction of the main fuel and the ignition fuel can be configured in such a way that the effect according to the invention, namely that the main fuel occurs firstly in the region of the propagation front and/or the jet tip, is achieved in a particularly suitable manner.

In this context, it is particularly advantageous, when, according to a particularly preferred embodiment of the operation method according to the invention, the introduction of the main fuel is effected via a first injection arrangement of an injection device, and during or after the introduction of the main fuel, the main fuel is spatially redirected in the combustion chamber, in particular by impulse diversion. This can be achieved in particular by recirculating the main fuel or the injected quantity of the main fuel to a location and/or a spatial region of the first injection arrangement and/or with an alignment to a location and/or a spatial region of the first injection arrangement, for example with a focus on an outlet opening, such as an injection nozzle or the like.

In this context, it may be particularly advantageous, when, according to a further development of the operation method according to the invention, a diversion of the main fuel or of the quantity of the injected main fuel is effected by means of one or more recesses and/or contours in a piston crown of a piston in a cylinder chamber, forming the combustion chamber, of a cylinder of the internal combustion engine.

In this case, the introduction of the main fuel or the quantity of main fuel can be performed at least approximately with spatial alignment to one or more recesses and/or contours in the piston crown and/or to one apex or more apexes of one or more recesses and/or contours in the piston crown.

In particular, it is advantageous, when, according to another configuration form of the operation method according to the invention, for or during the introduction of the main fuel, a quantity of the main fuel in the form of a combustion gas flow is introduced into the combustion chamber via one or the first injection arrangement in such a way that the combustion gas flow is or will be aligned with the one or the plurality of recesses and/or contours, such that the combustion gas flow, flows or enters, starting from the outlet from the first injection arrangement as a foot point, essentially along a wall of the recess and/or along the contour, is deflected, diverted and/or recirculated in its direction of flow by the wall of the recess and/or by the contour, and flows on or out along the wall of the recess and/or along the contour essentially in the direction of the foot point or of an end point corresponding to the foot point.

Alternatively or additionally, the modalities of introducing, distributing and/or igniting the ignition fuel can also be adapted accordingly.

Thus, according to another advantageous further development of the operation method according to the invention, for or during the introduction of the ignition fuel, a quantity of the ignition fuel can be introduced into the combustion chamber via a second injection arrangement of the injection device with an alignment to the one or more recesses and/or contours and/or with an alignment to the end point and/or the location and/or the region of the jet tip and/or the propagation front of the quantity of introduced main fuel—in particular at a desired and/or predetermined ignition time point.

To further reduce methane slip, lean zones of the combustion gas jet of the injected main fuel can be taken into account, which are formed only after the end of injection, for example in peripheral regions of the combustion gas jet, in particular at the jet foot and/or in the wake of the gas jet.

Therefore, it is of particularly advantageous, when, according to another advantageous embodiment of the operation method according to the invention, for or during the introduction of the ignition fuel, a or the quantity of the ignition fuel is introduced into the combustion chamber via the second injection arrangement of the injection device with its alignment, such that, at the time point of the self-ignition of the ignition fuel, a tangential ignition and/or an ignition of the main fuel also is performed at or in a point or region facing away from the jet tip and/or the propagation front of the main fuel, in particular with respect to the propagation path of the main fuel, in particular at or in a region of a jet foot of the combustion gas jet of the main fuel and/or in a lateral region of the combustion gas jet between and/or laterally to a connection between jet foot and jet tip.

In another advantageous further development of the operation method according to the invention, for or during the introduction of the main fuel, a quantity of the main fuel is or will be introduced into the combustion chamber in the form of a combustion gas flow via the first injection arrangement, such that the combustion gas flow is aligned with a partition wall of directly adjacent recesses and/or contours, so that the fuel gas stream, starting from the outlet from the first injection arrangement, is divided into partial streams at the partition wall and is distributed to the directly adjacent recesses and/or contours, and a respective partial stream flows or enters substantially along a respective wall of a respective recess and/or along a respective contour, is deflected or diverted in its flow direction by the wall of the respective recess and/or by the respective contour, and flows on or out along the wall of the respective recess and/or along the respective contour 52k substantially in the direction of the foot point or an end point corresponding to the foot point.

In such a procedure, it is particularly advantageous, when, for or during the introduction of the ignition fuel, one or the quantity of the ignition fuel 64 is introduced into the combustion chamber via one or the second injection arrangement of the injection device and divided into partial streams, and specifically respectively with an alignment to a respective recess and/or contour and/or with a respective alignment to a respective end point, a respective location and/or a respective region of an jet tip and/or a propagation front of a divided quantity of introduced main fuel, in particular at a desired and/or predetermined ignition time point.

The invention further relates to an internal combustion engine as such.

According to the invention, the proposed internal combustion engine is adapted to be operated according to, with or in an HPDF operation method configured according to the invention.

In an advantageous further development of the internal combustion engine according to the invention, this comprises a cylinder, which forms a combustion chamber, in which a piston is guided for an up-and-down movement, of the internal combustion engine in its interior and cylinder space.

Furthermore, an injection device is formed for introducing a main fuel and an ignition fuel, wherein a piston crown of the piston comprises one or more recesses and/or contours, which are arranged for deflecting and/or diverting a quantity of introduced main fuel, in particular in spatial-temporal coordination with the injection device.

Furthermore, the present invention also provides a working device, which may, for example, but not limited to, be formed as a vehicle.

The working device according to the invention comprises a drivable assembly and an internal combustion engine as drive for the assembly, wherein the internal combustion engine is configured in the way and manner according to the invention.

Further details, advantages and features of the present invention will be apparent from the following description of embodiments based on the drawing.

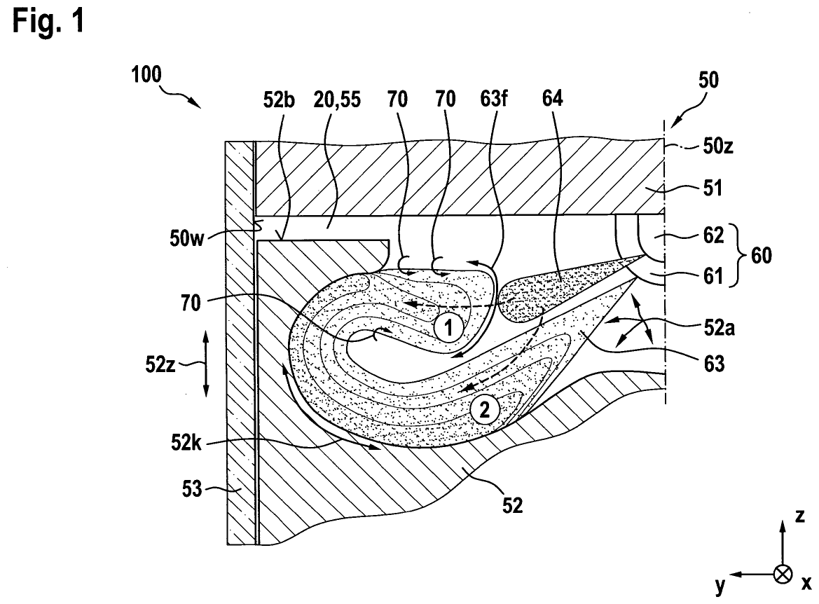

FIG. 1 shows, in the form of a vertical cross-sectional view, part of an embodiment of an internal combustion engine configured according to the invention, which can be used by an HPDF operation method according to the invention.

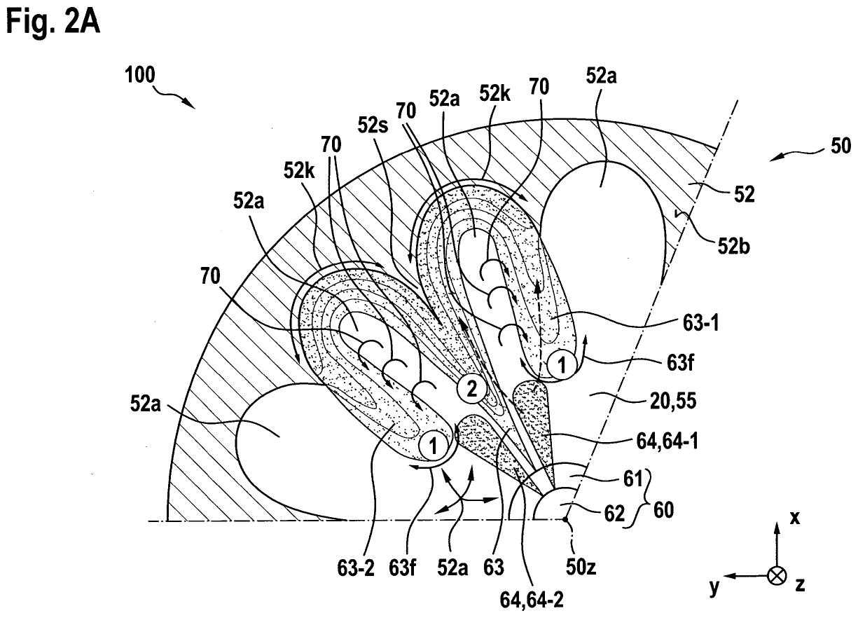

FIG. 2A shows, in the form of a lateral cross-sectional view, part of another embodiment of an internal combustion engine configured according to the invention, which can be used by an HPDF operation method according to the invention.

FIG. 2B also shows, in the form of a lateral cross-sectional view, part of an alternative embodiment of an internal combustion engine configured according to the invention, which can be used by an HPDF operation method according to the invention.

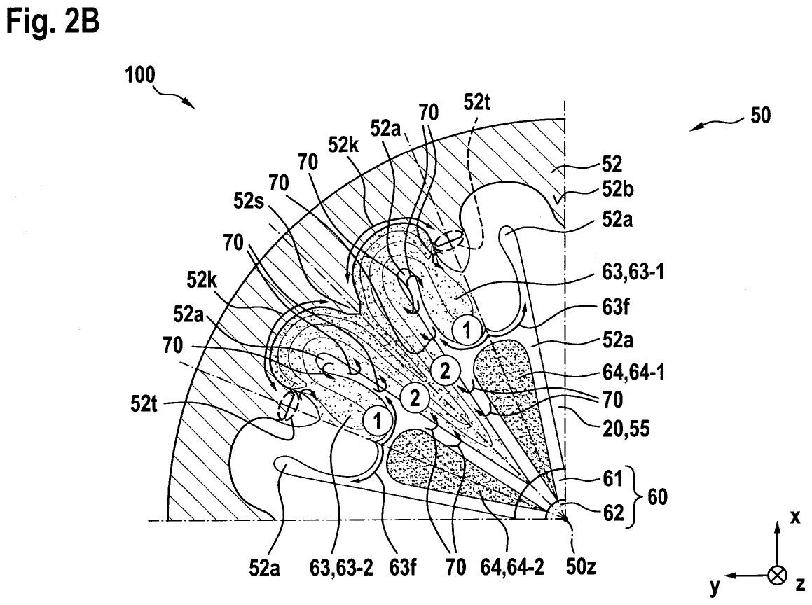

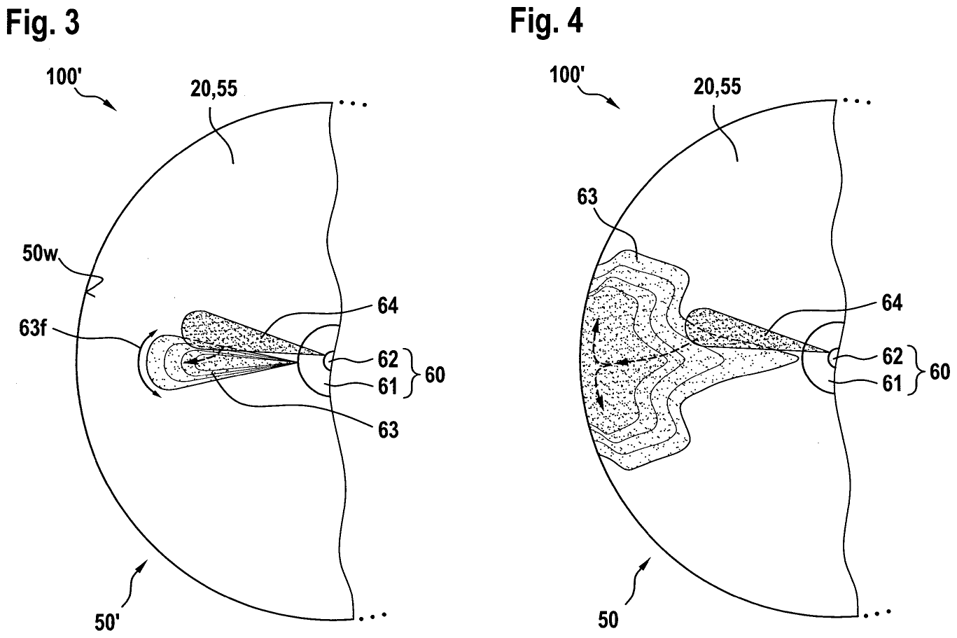

FIGS. 3 and 4 show, in the form of lateral cross-sectional views, situations during operation of conventional internal combustion engines with an HPDF operation method.

In the following, with reference to FIGS. 1 to 4, embodiments and the technical background of the invention are described in detail. Identical and equivalent elements and components, as well as elements and components acting identically or equivalently, are designated by the same reference signs. The detailed description of the designated elements and components is not reproduced in each case of their occurrence.

The features and further characteristics shown can be isolated from one another in any form and combined with one another as desired without departing from the essence of the invention.

FIG. 1 shows, in the form of a vertical cross-sectional view, part of an embodiment of an internal combustion engine 100 configured according to the invention, which can be used by an HPDF operation method according to the invention. FIG. 1 illustrates a variant of the process according to the invention with vertical jet diversion, e.g. in a plane containing the cylinder axis 50z.

The internal combustion engine 100 shown in FIG. 1 is represented here schematically by part of a cylinder 50 with a cylinder head 51, a piston 52 and a cylinder jacket 53, wherein the combustion chamber wall 50w is defined by the latter. Basically, the cylinder 50 is aligned approximately rotationally symmetrical to the cylinder axis 50z—here parallel to the z-direction. The piston 52 is arranged in the cylinder 50 movably along the cylinder axis 50z, i.e. in the z-direction, and is driven by means of a corresponding timing and by the combustion of the fuel in the combustion chamber 20 formed by the cylinder chamber 55 and a corresponding downstream transmission to perform a back-and-forth movement and, in the case of FIG. 1, an up-and-down movement 52z.

In FIG. 1, the combustion chamber 20 and as such the interior 55 of the cylinder 50 is limited above the cylinder head 51, below the piston 52 and in particular the piston crown 52b and on the side of the cylinder 53 and the corresponding cylinder wall 50w, which may also be referred to as the combustion chamber wall 50w and is temporally variable due to the up-and-down movement of piston 52 in the common way and manner for internal combustion engines.

According to the invention, the bottom 52b of the piston 52 comprises one or more recesses 52a and/or contours 52k. As already explained in detail above, any recesses 52a and/or contours 52k are formed in order to deflect or diverse, in cooperation with an injection device 60 and its first and second injection nozzles 61 and 62, respectively, for the pressurized introduction of a nonself-ignition or gasoline engine fuel as the main fuel 63 and a self-igniting or diesel fuel as ignition fuel 64, and in particular to recirculate a quantity of injected main fuel 63 in the direction of the place of injection, for example in the direction of an outlet hole of a nozzle or the like, wherein, however, boundary conditions relating to no or a minimum overlap of the jet with itself can be advantageously fulfilled.

In FIG. 1, the diversion of the quantity of main fuel 63 introduced is performed in a vertical direction, e.g. in a plane containing the cylinder axis 50z. This means that after the introduction via the first injection nozzle 61, the main fuel flows along the contour 52k of the recess 52a in the bottom 52b of the piston 52 and leaves the recess 52a of the piston 52 in the direction of the first injection nozzle 61 and its outlet hole.

In the meantime, a quantity of the ignition fuel 64 has been introduced through the second injection nozzle 62 of the injection device 60 in the direction of the propagation front 63f of the main fuel 63, such that, at the time point of self-ignition of the introduced ignition fuel 64, the ignition of the main fuel 63 begins in the region of the propagation front 63f and/or in the region of the so-called jet tip.

This last aspect can, in certain embodiments, be taken as a basis quite generally in the method according to the invention.

Basically, in connection with the illustrations of FIG. 1 and—subsequently—FIGS. 2A and 2B, the mixing field is shown at a time point shortly after the end of gas injection. This is recognizable by the lean zones near the nozzle outlet, where pure fuel is naturally found beforehand.

The mixing field shown corresponds to the one at which the combustion begins. Whether location 1 is shortly before location 2 or vice versa, may be less relevant in certain embodiments.

FIG. 2A shows, in the form of a lateral cross-sectional view, a part of another embodiment of an internal combustion engine 100 configured according to the invention, which can be used by an HPDF operation method according to the invention. FIG. 2A illustrates a variant of the method according to the invention with horizontal jet diversion, e.g. in a plane perpendicular to a cylinder axis 50z, which in turn is aligned parallel to the z-direction in the arrangement according to FIG. 2.

In addition, in this variant, the gas jet of the main fuel 63 is divided by a separating bar 52s of directly adjacent recesses 52a in the piston crown 52 into two partial jets 63-1, 63-2, each of which is recirculated approximately in the direction of the outlet of the main fuel 63 from the first nozzle 61 by diversion along the contours 52k.

Accordingly, it may be optionally advantageous, when respective partial jets 64-1, 64-2 corresponding to the two partial jets 63-1, 63-2 of the main fuel 63 are introduced for ignition and quasi touch the corresponding locations 1, i.e. the fronts 63f, during ignition.

In particular, FIG. 2A describes a situation, in which, for or during the introduction of the main fuel 63, a quantity of the main fuel 63 is or will be introduced into the combustion chamber 20 in the form of a combustion gas flow via the first injection arrangement 61, such that the combustion gas flow is aligned with a partition wall 52s of directly adjacent recesses 52a and/or contours 52k, so that, starting from the outlet from the first injection arrangement 61, the fuel gas flow is divided at the partition wall 52s into partial streams 63-1 and 63-2 and is divided between the directly adjacent recesses 52a and/or contours 52k, and a respective partial stream 63-1, 63-2 flows or enters substantially along a respective wall of a respective recess 52a and/or along a respective contour 52k, is deflected or diverted in its direction of flow by the wall of the respective recess 52a and/or by the respective contour 52k, and flows on or out along the wall of the respective recess 52a and/or along the respective contour 52k essentially in the direction of the foot point or an end point corresponding to the foot point.

In such a procedure, it is particularly advantageous, when, for or during the introduction of the ignition fuel 64, one or the quantity of the ignition fuel 64 is divided into partial streams 64-1, 64-2 via one or the second injection arrangement 62 of the injection device 60 and introduced into the combustion chamber 20, and specifically respectively with an alignment to a respective recess 52a and/or contour 52k and/or with a respective alignment to a respective end point, a respective location 1 and/or a respective region of an jet tip 63f and/or a propagation front 63f of a divided quantity of introduced main fuel 63, in particular at a desired and/or predetermined ignition time point.

With reference to the embodiment of the present invention shown in FIG. 2A, it can be advantageous when the number of injection points for the two fuels are not the same.

However, it can then be further advantageous, when a present rotational symmetry is taken into account in the arrangement according to FIG. 2A.

It is not intended in every case that two pilot jets are arranged and/or formed directly adjacent to each other before a next or subsequent gas injection is or will be formed and/or arranged in the circumferential direction.

These aspects are clarified in the context of the embodiment according to FIG. 2B.

FIG. 2B also shows, in the form of a lateral cross-sectional view, part of an alternative embodiment of an internal combustion engine configured according to the invention, which can be used by an HPDF operation method according to the invention. In essence, the structure shown in FIG. 2B and its use are identical to those described in the context with the structure shown in FIG. 2A.

Commonalities and differences derive in particular from the following annotations:

(1) The jet image in FIG. 2B is configured in particular essentially symmetrically, wherein the two simultaneous partial jets 64-1 and 64-2 of the ignition fuel 64 as pilot jets respectively ignite adjacent partial jets 63-1 and 63-2 of the main fuel 63. In the illustration according to FIG. 2B, the number of jets for both fuels 63 and 64 is the same in this embodiment, but it can in principle also be or will be selected differently.

(2) The arrows 70 again symbolize the mixing of air from the ambient atmosphere into the fuels and in particular into the main fuel 63.

(3) In the embodiment shown in FIG. 2B, the bars or partitions 52s between two directly adjacent recesses 52a of a pair of recesses 52a are not as tapered in the direction of the cylinder axis 50z as in the embodiment shown in FIG. 2A. In other words, there are no tapered edges in the combustion chamber 20.

(4) Alternatively or additionally, the height of the outlet 52t between directly adjacent pairs of recesses 52a can be as short as possible and/or formed with a step to facilitate the mixing and in particular the blending 70 of ambient air or ambient atmosphere into the main fuel 63.

(5) Deflection or diversion of the jets 63-1, 63-2 of the main fuel 63 is performed by aligning the jets 63-1, 63-2 with the contour 52k of the recesses 52a and flowing along this contour 52k. Thus, a specific objective of the recess 52a, which can also be referred to as a trough, can receive as much of the jet impulse as possible, so that it actually flows back, and specifically with respect to the original point, in particular the location of the recess of the first injection nozzle or injection arrangement 61 for the main fuel 63.

(6) This leads to a gradual diversion, in contrast to a conventional frontal impact on a wall 50w of the combustion chamber 20, which would conventionally lead to a transformation of the impulse into turbulence at the wall 50w.

(7) This concerns both the general shape of the contour 50k and, in particular, the region, in which the jet impacts.

(8) In preferred embodiments, the alignment of the flowing of the partial jets 63-1, 63-2 of the main fuel 63 towards the pilot jet or jets 64-1, 64-2 of the ignition fuel 64 is performed with the end point of the contour 52k.

(9) This can mean specifically that a jet or partial jet 63-1, 63-2 of the main fuel 63 should not hit itself or at least hit itself as late as possible.

(10) An overlap leads to worse mixing 70 of air, which should be avoided.

(11) This degree of diversion is largely determined by the direction and form of the contour 52k at its end.

(12) Generally, in the region of the diversion, the fattest regions are found directly on the wall 52w of the combustion chamber 20, since no air can be blended in here.

(13) To ensure that these fat regions continue to blend in air as soon as possible after leaving the trough 52a, the outlet 52t should be configured as short as possible (in the proximity of 52b in FIG. 1, the shoulder between the piston gap and the trough).

(14) Regarding the interaction between gas jet and diesel jet in the tangential region, for example at location 2, investigations show that the jets still interact even at angles between the axes above about 30°, although the opening angle is about 20° respectively (diesel or ignition fuel 64 somewhat less, gas or main fuel 63 more). The reason is the strong suction effect of the gas jet of the main fuel 63, which draws the diesel cloud towards it. This process takes some time, which can be performed to let the diesel or general ignition fuel 64 penetrate until the ignition at location 1 before an ignition is performed at location 2. In addition, again for a good burnout of the two jets, the interaction should generally be kept low. It follows from all these arguments that the angle between the jets should preferably be in the region of about 15° to about 30°.

FIGS. 3 and 4 illustrate, in the form of lateral cross-sectional views, situations in the operation of conventional internal combustion engines 100′ with an HPDF operation method. FIGS. 3 and 4 thus illustrate the two possible present operation strategies of an HPDF combustion method, wherein the combustion chamber wall 50w, the fuel injector 60, the diesel jet as ignition fuel 64 and the gas jet as main fuel 63 are illustrated.

In particular, FIG. 3 illustrates a situation in which the ignition fuel 64 is injected and ignited at a comparatively early time point compared to the expansion of the main fuel 63 into the combustion chamber 20 formed by the conventional piston 50′ with its cylinder chamber 55. In this situation, the jet tip or propagation front 63f of the main fuel 63 has not yet reached the cylinder wall 50w after injection.

In contrast, FIG. 4 shows a situation in which the ignition fuel 64 is injected into the combustion chamber 20 and ignited at a comparatively late time point compared to the expansion of the main fuel 63. In this situation, the jet tip or propagation fountains 63f of the main fuel 63 has already reached the cylinder wall 50w after injection and has been deflected or diverted, in particular in the sense that in such a process the front has respectively impacted the wall and spreads out to the side.

The impact of the jet of the main fuel 63 on the piston crown 52b is a decisive process in the injection of fuel and can usually not be prevented in internal combustion engines.

The conventional tangential ignition, as illustrated for example in FIG. 3, in particular for example due to an early ignition time point in the proximity of the outlet openings of the injection device 60, leads experientially to comparatively bad emission characteristics, and specifically with regard to soot formation as well as with regard to methane slip.

An additional or alternative core aspect of the present invention is to, by a purposeful deflection and/or diversion of the jet of the main fuel 63, in particular by interplay of the jet of main fuel 63 with corresponding recesses 52a and/or contours 52k on the piston crown 52b of the respective piston 52, aligning the jet of main fuel 63, and in particular the jet tip or propagation front 63f, with the jet of ignition fuel 64, in other words with the pilot, to optimize the ignition and/or the combustion of the main fuel 63, so that soot formation and/or methane slip are and will be reduced or prevented.

These and other aspects of the present invention are also further explained with reference to the following illustration:

The use of natural gas or other alternative fuels in combustion engines is a promising way to reduce greenhouse gases.

In order to be able to fully utilize the potential of natural gas or the like as a fuel with regard to the reduction of CO₂ emissions, the aim must be to avoid methane emissions. Engines with homogeneous premixing of natural gas have a significant methane slip, which contributes to global warming many times more than CO₂ and negates any advantage in terms of CO₂ emissions, as explained in the context of the sources cited below [1], [2].

One possibility for avoiding methane emissions is the HPDF combustion method (HPDF: High Pressure Dual-Fuel) with diesel pilot ignition. This combustion method provides for a high-pressure blowing of natural gas into the combustion chamber, wherein the ignition is performed by a small quantity of diesel fuel, which is termed as diesel pilot. This is also explained in detail in the context of the source given below [3].

This procedure is particularly concerned with targeted formation of a mixture by injection, and specifically so that no lean zones are created on a combustion chamber wall and/or in a piston gap, which, for example, do not burn off due to flame extinguishing.

In principle, the combustion method can also be implemented with other gasoline engine fuels, in other words fuels that are not suitable for compression-self-ignition, e.g. with methanol, ethanol or the like.

The present invention is also not limited to the use of natural gas as the main fuel.

Aspects of the general combustion method are known from numerous publications, e.g. from the sources listed below [3], [4], [5].

Conventionally, the following problematic circumstances arise:

Geometrically, the origin of gas and diesel jets as well as the angle between the jets are fixed for the diesel pilot as ignition fuel 64 and for the gasoline engine main-fuel 63 in the engine 100, 100′.

The interplay of the two jets 63 and 64 can only be controlled by the respective start of injection and the respective injection duration.

Unlike in classic diesel engines, however, premixing and ignition time point can be varied independently from each other by the two jets 63 and 64.

Furthermore, in contrast to classic gasoline engines with intake manifold injection and homogeneously premixed fuel-air mixture in the combustion chamber, there are always fat and lean zones in the HPDF combustion method, regardless of the operating strategy.

The problem here is that soot is inevitably formed during the combustion of a fat fuel-air mixture. Soot and particle emissions have a negative effect on the overall emission behavior and may have to be removed with a costly exhaust gas aftertreatment.

The previous and conventional fuel distribution in the combustion chamber is explained by way of example in the context of FIGS. 3 and 4 using two possible conventional operating strategies.

The respective underlying operating points represent possible extreme cases of an earlier or later injection of the diesel pilot into the gas jet, wherein the strategy in an engine can be flexibly varied and optimized depending on the load point and thus the injection duration.

### Conventional Operating Strategy 1

According to the illustration from FIG. 3, the gas jet of the main fuel 63 is ignited shortly after the opening of the injector by interplay or interaction with the diesel jet as ignition fuel 64. The combustion and mixing take place simultaneously—as is usual with classic diffusion flames. A highly sooty combustion is the inevitable consequence of the continuous injection of fresh fuel into the already burning jet region. With this conventional operating strategy, gentle combustion processes are possible, which, however, lead to disadvantages in efficiency due to the slow mixture-limited burn-up.

### Conventional Operating Strategy 2

According to the illustration from FIG. 4, the gas jet of the main fuel 63 is ignited comparatively late and in extreme cases, for example, shortly after the end of the injection of the gas by interplay or interaction with the diesel jet as ignition fuel 64. The gas jet 63 still impacts the combustion chamber wall 50w during the injection and spreads along it. The regions far from the wall can mix further with air, those close to the wall remain fat and cannot mix further even by remaining for a longer time. After ignition, the flame is firstly carried into the fat regions due to the highest velocities at this point, which means that sooty combustion cannot be ruled out with this strategy either. The associated rapid flame propagation also leads to a high tip in heat release, which is to be avoided due to the associated sharp rise in pressure. This limits this operating strategy for use in partial load ranges. Meanwhile, the lean zones in the marginal region can blend in further, causing methane emissions to rise.

The conflicting field between the operating strategies 1 and 2 known from the conventional procedure is illustrated in detail in the source given below [5].

### Aspects of the Procedure According to the Invention

In order to reduce or even avoid soot formation, zones of fat mixture in the region of the flame must be avoided. In other words, in the regions of fat mixture, before they are reached by the flame, the air supply must be improved or given more time to blend in and/or thin out. At the same time, locally very lean regions should be avoided to prevent methane slip by early combustion.

In conventional diesel engines, it is common to improve the mixture by a jet diversion in order to accelerate the burnup in the already burning diesel jet. However, since the gas jet is nonself-ignited, the same effect can be utilized to produce a beneficial mixing field even before combustion. For this purpose, a horizontal (e.g. in a plane perpendicular to the cylinder axis 50z) or also vertical diversion (in a plane containing the cylinder axis) is conceivable, wherein the jet can also be split. This is illustrated in FIGS. 1 and 2, respectively. While the fattest regions will continue to be formed on the wall shortly after the end of injection, the impulse diversion will lead to improved blending in further downstream.

The gas jet of main fuel 63 can now be ignited firstly in those regions in the proximity of the injector 60, which have already had enough time to mix with the combustion chamber air. The inflaming at the jet tip or propagation fountain 63f, i.e., at the location 1 of the gas jet of the main fuel 63, limits the pressure peaks, since the propagation is now performed in opposition to the flow velocity, and at the same time allows the further leaning of the fat regions over the remaining jet surface in the rear region. It is also advantageous to continue to allow a tangential ignition at the jet foot geometrically at location 2. In this way, the lean zones that form here after the end of injection are ignited comparatively early temporally and methane slip is thus avoided or at least reduced. A reduction of the tips can be seen in the combustion process due to this type of ignition, wherein the process remains compact when broadening at the same time. This is advantageous for high efficiency.

Furthermore, a tangential ignition can be mandatory or at least advantageous for a part-load region, because a sufficient diversion is not possible here due to the shorter injection duration.

In particular, smaller quantities of fuel are required in this case, namely due to a temporally shorter injection and/or due to a lower pressure used. In such a case, however, the impulse and/or thus the penetration behavior can be reduced probably, so that the jet of main fuel may no longer flow back to the pilot. In such cases, no ignition is performed at location 1.

The general problem of a high pressure peak with this classic ignition type is not so severe here, since generally a lower fuel quantity is or can be introduced. In addition, the highest soot emissions are a problem especially at full load, particularly when fuel is added for a very long time.

In this context, it is of particular importance for preferred embodiments of the method according to the invention that, not in every case, an exact temporal sequence of the ignition of the main fuel 63 at the locations 1 and 2 is in the foreground, but rather the way and manner, in which a flame in the main fuel 63 reaches, for example, the location 1. This can mean, for example, that the partial jet 63-1, 63-2 of the main fuel 63 at location 1 is ignited directly by the pilot jet 64-1, 64-2, in other words by the auxiliary fuel 64 and its flame, and not by the propagation of the flame in the main fuel 63, for example from location 2 to location 1.

In addition to the foregoing written description of the invention, explicit reference is hereby made to the graphic illustration of the invention in FIGS. 1 through 4 for supplemental disclosure thereof.

### LITERATURE

[1] Anderson, M., Salo, K., and Fridell, E., 2015. “Particle and Gaseous Emissions from an LNG Powered Ship”. Environmental science & technology, 49(20), pp. 12568-12575.

[2] https://www.dieselnet.com/tech/catalyst_methane.php

[3] McTaggart-Cowan, 2006. “Pollutant Formation in a Gaseous-Fuelled, Direct Injection Engine”. Ph.D. Thesis, University of British Columbia, Vancouver, https://open.library.ubc.ca/cIRcle/collections/ubctheses/831/items/1.0080746

[4] Faghani, E., Kheirkhah, P., Mabson, C. W., McTaggart-Cowan, G., Kirchen, P., and Rogak, S., 2017. “Effect of Injection Strategies on Emissions from a Pilot-Ignited Direct-Injection Natural-Gas Engine-Part II: Slightly Premixed Combustion”. In WCXTM 17: SAE World Congress Experience, Vol. 2017-01-0763 of SAE Technical Paper Series.

[5] McTaggart-Cowan, G. P., Mann, K., Huang, J., Wu, N., and Munshi, S. R., 2012. “Particulate Matter Reduction from a Pilot-Ignited, Direct Injection of Natural Gas Engine”. In ASME 2012 Internal Combustion Engine Division Fall Technical Conference, Vol. ICEF2012-92162, p. 427.

### LIST OF REFERENCE SIGNS

1 end/tip of gas jet/jet of main fuel 63

2 location/space region for tangential ignition

20 combustion chamber

50 cylinder

50′ conventional cylinder

50w combustion chamber wall, cylinder wall

50x cylinder axis, symmetry axis

50z cylinder axis

51 cylinder head

52 piston

52a cutout/recess (at/in piston crown 52b)

52b piston crown, bottom of piston

52k contour

52s bar/partition wall between two directly adjacent cutouts 52a

52t outlet/bar/partition wall between directly pairs of adjacent cutouts 52a

52z (direction of) up-and-down movement of piston 52 in combustion chamber 55

53 cylinder barrel

55 cylinder chamber, interior of cylinder

60 injection device, injector

61 (first) injection nozzle/injection arrangement (for main fuel 63)

62 (second) injection nozzle/injection arrangement (for ignition fuel 64)

63 main fuel, nonself-ignition or gasoline engine fuel

63-1 partial injection

63-2 partial injection

63f propagation front, jet tip

64 ignition fuel, self-ignition or diesel fuel

64-1 partial injection

64-2 partial injection

70 location/process of air mixing, especially into main fuel 63

100 internal combustion engine

100′ conventional internal combustion engine

x spatial direction

y spatial direction

z spatial direction

1. An HPDF operation method for an internal combustion engine with internal formation of a mixture and self-ignition, wherein
for a combustion cycle of an operation cycle under high pressure, the introduction of a nonself-ignition or gasoline engine fuel for introducing a main fuel at a first time point and the introduction of a self-ignition or diesel fuel for introducing an ignition fuel at a second time point, into a combustion chamber of the internal combustion engine are at least initiated and/or performed,
a self-ignition of the ignition fuel and, with the self-ignition, a nonself-ignition of the main fuel are effected, and
the self-ignition of the ignition fuel is performed temporally and/or spatially in such a way that the main fuel is ignited at a location and/or in an region of an jet tip and/or a propagation front of an amount of introduced main fuel, in particular temporally at first.

2. The operation method according to claim 1, in which, the second time point is temporally not before the first time point and preferably after the first time point.

3. The operation method according to claim 1, in which,
the introduction of the main fuel is effected via a first injection arrangement an injection device, and
during or after the introduction of the main fuel, the main fuel is spatially diverted in the combustion chamber, preferably by being returned to or aligned with a location and/or a spatial region of the first injection arrangement.

4. The operation method according to claim 3, in which,
a diversion of the main fuel is effected via one or more cutouts and/or contours in a piston crown of a piston in a cylinder chamber of a cylinder of the internal combustion engine, wherein the cylinder chamber forms the combustion chamber, and preferably
the introduction of the main fuel is effected—at least approximately—with spatial alignment with one or more cutouts and/or contours in the piston crown and/or the apex or apexes thereof.

5. The operation method according to claim 3, in which, for or during the introduction the main fuel, an amount of the main fuel in the form of a combustion gas stream is introduced into the combustion chamber via the first injection arrangement in such a way that the combustion gas stream is or becomes aligned with one or more recesses and/or contours, such that, starting from the outlet from the first injection arrangement as a foot point, the combustion gas stream flows or enters essentially along a wall of a cutout and/or along a contour, is deflected or diverted in its flow direction by the wall of the cutout and/or by the contour, and continues to flow or exits along the wall of the cutout and/or along the contour essentially in the direction of the foot point or of an end point corresponding to the foot point.

6. The operation method according to claim 3, in which, for or during the introduction of the ignition fuel, an amount of the ignition fuel is introduced via a second injection arrangement of the injection device with an alignment with one or more cutouts and/or contours and/or with alignment with the end point, the location and/or the region of the jet tip and/or the propagation front of the amount of main fuel introduced—preferably at a desired and/or predetermined ignition time point—into the combustion chamber.

7. The operation method according to claim 3, in which, for or during the introduction of the main fuel, an amount of the main fuel in the form of a combustion gas flow is introduced into the combustion chamber via the first injection arrangement in such a way that the combustion gas flow is or becomes aligned with recesses and/or contours, which are directly adjacent to a partition wall, so that, starting from the exit from the first injection arrangement, the combustion gas stream is divided at the partition wall into partial streams and distributed to the directly adjacent recesses and/or contours, and a respective partial stream flows or enters substantially along a respective wall of a respective cutout and/or along a respective contour, is deflected or diverted in its flow direction by the wall of the respective cutout and/or by the respective contour, and continues to flow or exits along the wall of the respective cutout and/or along the respective contour substantially in the direction of the foot point or of an end point corresponding to the foot point.

8. The operation method according to claim 1, in which, for or during the introduction of the ignition fuel, an amount of the ignition fuel is divided into partial streams via an injection arrangement of the injection device and is introduced into the combustion chamber, and more specifically respectively with an alignment with a respective cutout and/or contour and/or with a respective alignment with a respective end point, a respective location (1) and/or a respective region of an jet tip and/or a propagation front of the amount of introduced main fuel divided into partial streams, preferably at a desired and/or predetermined ignition time point.

9. The operation method according to claim 1, in which, at or during the introduction of the ignition fuel, an amount of the ignition fuel is introduced into the combustion chamber via the second injection arrangement of the injection device with its alignment in such a way that, at the time point of the self-ignition of the ignition fuel, a tangential ignition and/or an ignition of the main fuel also occurs at or in the point or region facing away from the jet tip and/or the propagation front of the main fuel—preferably with respect to the propagation path of the main fuel (63)—preferably at or in the region of an injection foot of the main fuel.

10. An internal combustion engine,
which is arranged to be operated with, according to or in an operation method according to claim 1, and
which for this purpose preferably comprises a cylinder, which in its interior and cylinder space forms a combustion chamber of the internal combustion engine, in which a piston is guided for an up-and-down movement and an injection device is formed for introducing a main fuel and an ignition fuel,
wherein a piston crown of the piston comprises one or more cutouts and/or contours, which are arranged for deflecting and/or diverting introduced main fuel, preferably in spatial-temporal coordination with the injection device.

11. A working device and preferably vehicle,
with:
a drivable assembly and
an internal combustion engine as power unit for the assembly,
wherein the internal combustion engine is formed according to claim 10.

12. The operation method according to claim 4, in which, for or during the introduction the main fuel, an amount of the main fuel in the form of a combustion gas stream is introduced into the combustion chamber via the first injection arrangement in such a way that the combustion gas stream is or becomes aligned with one or more recesses and/or contours, such that, starting from the outlet from the first injection arrangement as a foot point, the combustion gas stream flows or enters essentially along a wall of a cutout and/or along a contour, is deflected or diverted in its flow direction by the wall of the cutout and/or by the contour, and continues to flow or exits along the wall of the cutout and/or along the contour essentially in the direction of the foot point or of an end point corresponding to the foot point.

13. The operation method according to claim 4, in which, for or during the introduction of the ignition fuel, an amount of the ignition fuel is introduced via a second injection arrangement of the injection device with an alignment with one or more cutouts and/or contours and/or with alignment with the end point, the location and/or the region of the jet tip and/or the propagation front of the amount of main fuel introduced—preferably at a desired and/or predetermined ignition time point—into the combustion chamber.

14. The operation method according to claim 4, in which, for or during the introduction of the main fuel, an amount of the main fuel in the form of a combustion gas flow is introduced into the combustion chamber via the first injection arrangement in such a way that the combustion gas flow is or becomes aligned with recesses and/or contours, which are directly adjacent to a partition wall, so that, starting from the exit from the first injection arrangement, the combustion gas stream is divided at the partition wall into partial streams and distributed to the directly adjacent recesses and/or contours, and a respective partial stream flows or enters substantially along a respective wall of a respective cutout and/or along a respective contour, is deflected or diverted in its flow direction by the wall of the respective cutout and/or by the respective contour, and continues to flow or exits along the wall of the respective cutout and/or along the respective contour substantially in the direction of the foot point or of an end point corresponding to the foot point.

15. An internal combustion engine,
which is arranged to be operated with, according to or in an operation method according to claim 2, and
which for this purpose preferably comprises a cylinder, which in its interior and cylinder space forms a combustion chamber of the internal combustion engine, in which a piston is guided for an up-and-down movement and an injection device is formed for introducing a main fuel and an ignition fuel,
wherein a piston crown of the piston comprises one or more cutouts and/or contours, which are arranged for deflecting and/or diverting introduced main fuel, preferably in spatial-temporal coordination with the injection device.

16. An internal combustion engine,
which is arranged to be operated with, according to or in an operation method according to claim 3, and
which for this purpose preferably comprises a cylinder, which in its interior and cylinder space forms a combustion chamber of the internal combustion engine, in which a piston is guided for an up-and-down movement and an injection device is formed for introducing a main fuel and an ignition fuel,
wherein a piston crown of the piston comprises one or more cutouts and/or contours, which are arranged for deflecting and/or diverting introduced main fuel, preferably in spatial-temporal coordination with the injection device.

17. An internal combustion engine,
which is arranged to be operated with, according to or in an operation method according to claim 4, and
which for this purpose preferably comprises a cylinder, which in its interior and cylinder space forms a combustion chamber of the internal combustion engine, in which a piston is guided for an up-and-down movement and an injection device is formed for introducing a main fuel and an ignition fuel,
wherein a piston crown of the piston comprises one or more cutouts and/or contours, which are arranged for deflecting and/or diverting introduced main fuel, preferably in spatial-temporal coordination with the injection device.

18. An internal combustion engine,
which is arranged to be operated with, according to or in an operation method according to claim 5, and
which for this purpose preferably comprises a cylinder, which in its interior and cylinder space forms a combustion chamber of the internal combustion engine, in which a piston is guided for an up-and-down movement and an injection device is formed for introducing a main fuel and an ignition fuel,
wherein a piston crown of the piston comprises one or more cutouts and/or contours, which are arranged for deflecting and/or diverting introduced main fuel, preferably in spatial-temporal coordination with the injection device.

19. An internal combustion engine,
which is arranged to be operated with, according to or in an operation method according to claim 6, and
which for this purpose preferably comprises a cylinder, which in its interior and cylinder space forms a combustion chamber of the internal combustion engine, in which a piston is guided for an up-and-down movement and an injection device is formed for introducing a main fuel and an ignition fuel,
wherein a piston crown of the piston comprises one or more cutouts and/or contours, which are arranged for deflecting and/or diverting introduced main fuel, preferably in spatial-temporal coordination with the injection device.

20. An internal combustion engine,
which is arranged to be operated with, according to or in an operation method according to claim 7, and
which for this purpose preferably comprises a cylinder, which in its interior and cylinder space forms a combustion chamber of the internal combustion engine, in which a piston is guided for an up-and-down movement and an injection device is formed for introducing a main fuel and an ignition fuel,
wherein a piston crown of the piston comprises one or more cutouts and/or contours, which are arranged for deflecting and/or diverting introduced main fuel, preferably in spatial-temporal coordination with the injection device.
